(19) United States
(12) Patent Application Publication
(10) Pub. No.: US 2025/0214735 A1
(43) Pub. Date: Jul. 3, 2025

(54) CARD GAME EXPANSION

(71) Applicant: Doomlings, Inc., Los Angeles, CA (US)

(72) Inventors: Justus Meyer, Los Angeles, CA (US); Andrew Meyer, Los Angeles, CA (US); Anthony Rath, Los Angeles, CA (US); Eric McCoy, Los Angeles, CA (US); Chris Svehla, Los Angeles, CA (US)

(21) Appl. No.: 18/403,013

(22) Filed: Jan. 3, 2024

(51) Int. Cl. B65B 57/10; B41M 3/00; B65B 5/06

(52) U.S. Cl. CPC B65B 57/10; B65B 5/067; B41M 3/005

(57) ABSTRACT

Implementations herein may include methods, systems, and apparatuses enabling specification and production of expansion item sets that carry a randomized feeling from a player's perspective without degrading playability. Implementations may include generating expansion pack configurations based on an expansion item universe and a parameter function; filtering the multitude of expansion pack configurations to yield a manufacturing subset of expansion pack configurations; retrieving a design file corresponding to each expansion item specification, for example, from a database stored on an electronic storage device in electronic communication with the processor; associating each expansion item specification within the manufacturing subset of expansion pack configurations with the expansion item design file corresponding to the expansion item specification; based on the manufacturing subset of expansion pack configurations comprising the expansion item specifications having the expansion item design files associated therewith, generating the factory instructions; and sending the factory instructions to a factory to facilitate production.

### BACKGROUND

Board and card games offer a robust avenue for cognitive engagement. These games often require strategic thinking, problem-solving, and forward planning, allowing players to hone these mental faculties in an interactive environment. As individuals encounter varying scenarios and game states, they continuously adapt their strategies, optimizing their decisions based on predicted outcomes. This cognitive stimulation, often absent from passive forms of entertainment, can be both challenging and rewarding, making these games appealing for those seeking intellectual rigor.

Another reason people are drawn to board and card games is the social interaction they facilitate. These games are inherently communal, requiring players to engage with one another, negotiate, collaborate, or compete. This interactive dimension fosters a sense of camaraderie, builds relationships, and provides an avenue for communication. In an increasingly digital age where social interactions can often be reduced to online exchanges, board and card games offer a tangible, face-to-face interaction that can strengthen interpersonal bonds and provide a meaningful communal experience.

Playing these games can provide players a sense of achievement and escapism. Winning a game or even executing a well-thought-out strategy offers intrinsic satisfaction. This sense of accomplishment, combined with the immersive worlds many games present, allows players to temporarily escape from daily stresses or routine. The structured ruleset and the bounded reality of the game provide an environment where players can exercise control, experiment with choices, and experience the consequences in a safe setting, providing a fulfilling and cathartic experience.

### BRIEF DESCRIPTION OF THE FIGURES

For a fuller understanding of the nature and objects of the disclosure, reference should be made to the following detailed description taken in conjunction with the accompanying drawings, in which:

FIG. 1A illustrates a rules-based system for specifying and producing at least one expansion pack, according to one or more implementations herein;

FIG. 1B illustrates a packaging sequence according to one or more implementations herein;

FIG. 2. Illustrates an operational environment for one or more of the implementations herein;

FIG. 3 is a diagram of example components of a device, according to one or more implementations herein; and

FIG. 4 is a flowchart illustrating an example method for specifying and producing expansion item packs of various forms for base games, according to one or more implementations herein.

### DETAILED DESCRIPTION

It is to be understood that the invention is not limited in its application to the details of construction and the arrangements of components and/or method steps set forth in the following description or illustrated in the drawings, and phraseology and terminology used herein is for the purpose of description and should not be regarded as limiting. The invention is capable of other embodiments and of being practiced or being carried out in various ways. Accordingly, other aspects, advantages, and modifications will be apparent to those skilled in the art to which the invention pertains, and these aspects and modifications are within the scope of the invention, which is limited only by the appended claims.

Trading card games, sometimes known as collectible card games (TCGs), are games where players collect cards and build their personalized decks to duel against opponents. As such, TCGs present a conventional method of varying gameplay of a game. Over the years, TCGs have gained immense popularity, spawning global tournaments, vast player communities, and a secondary market for card trading. However, despite their widespread appeal, they come with their set of shortcomings.

One of the most prominent shortcomings of TCGs is the economic barrier to entry and sustained play. Rare and powerful cards tend to be expensive, sometimes reaching exorbitant prices on secondary markets. This “pay-to-win” model can put players at a disadvantage if they cannot afford to buy the most potent cards, limiting competitive diversity and potentially leading to a stagnant metagame. New players might be discouraged from entering the game due to the perceived cost barrier, and seasoned players might feel pressured to constantly invest to remain competitive.

Further, balancing a vast pool of cards is an inherent challenge in TCG design. As new expansions or sets are released, there's an inherent pressure to make newer cards desirable. This can sometimes lead to power creep, where newer cards are objectively more potent than older ones, rendering previous sets obsolete. Such trends can alienate long-term players and diminish the value of their past investments. Moreover, a poorly balanced game can lead to a limited number of dominant strategies, reducing the diversity and richness of gameplay experiences.

Physical TCGs also inherently suffer from portability and durability concerns. A player's deck or collection can be easily damaged, lost, or stolen. Transporting a sizable collection to events or tournaments can be cumbersome. Moreover, the need for physical proximity for gameplay limits spontaneous matches, especially compared to digital counterparts which allow for instant matchmaking. Additionally, the organization and management of ever-growing card collections can be daunting, requiring meticulous sorting, cataloging, and storage solutions.

Another conventional solution to varying gameplay related to base games sets are smallbox expansions. Smallbox expansions refer to supplementary game materials packed in smaller boxes than the core game. These expansions are designed to enrich the base game experience, often introducing new mechanics, components, or challenges. While smallbox expansions are generally embraced by dedicated fans looking for a fresh take on their favorite games, they come with inherent drawbacks.

One significant concern with smallbox expansions is the challenge of seamlessly integrating them into the base game. While these expansions aim to add depth or variety, they can sometimes complicate the game unnecessarily. Players might find themselves wrestling with a complex web of rules that disrupt the game's original flow. This can extend the game's duration, increase setup time, or make the gaming experience less intuitive, especially for newcomers who aren't familiar with the base game's mechanics.

While individual smallbox expansions might seem affordable, the cumulative cost of purchasing multiple expansions can quickly add up, approaching or even surpassing the cost of the original game. Players may feel the need to acquire several expansions to “complete” their experience, leading to significant financial investment. Moreover, not all expansions offer equal value; some might only marginally enhance the gameplay or offer components and mechanics that don't resonate with all players, leading to potential buyer's remorse.

With every additional expansion, storage becomes an increasing concern. Even though each expansion might be in a “small” box, accumulating several of them can present logistical challenges. Players might struggle to consolidate components from the base game and its expansions efficiently. This can also make the game less portable, as players have to transport the original game box along with several expansion boxes. Additionally, organizing and ensuring that components don't get mixed up or lost becomes increasingly complex.

Further, conventional attempts at providing expansion capabilities to tabletop games, trading card games, or other games presents the technical challenge of a ballooning of the number of stock keeping units (SKUs) a seller must manage. A seller may be incapable of handling a quantity of SKUs to provide what could feel for the player to be a random expansion experience.

Further, conventional attempts at providing random expansions lead to inherent problems, both in production and in gameplay. Truly random-generated expansions inherently have a non-zero chance of having all expansion items identical. Two truly random expansion sets could also be the same, resulting in a situation where a buyer has unintentionally purchased duplicates. Finally, gameplay may be degraded by an unbalance of component strength, leading to undesirable gameplay, or worse, unplayability.

Implementations herein solve some or all of the shortcomings of conventional expandable games. Implementations may not require multiple purchases to enhance playability of a game, and may not require purchases by multiple players of the same game.

Implementations herein may include methods and systems, which may be implemented using a processor to produce expansion item (e.g., cards, mechanics, categories, jokes, gameplay experiences, scenarios, goals, missions, boards, resources, heroes, avatars, boardstates, rule variants, etc.) packs of various forms for base games.

A technical advantage provided by implementations herein is the ability to consolidate the expansion products into a single SKU or smaller quantity of SKUs. This can reduce the amount of computing power or recordkeeping resources required of the seller and any intermediary channels of commerce.

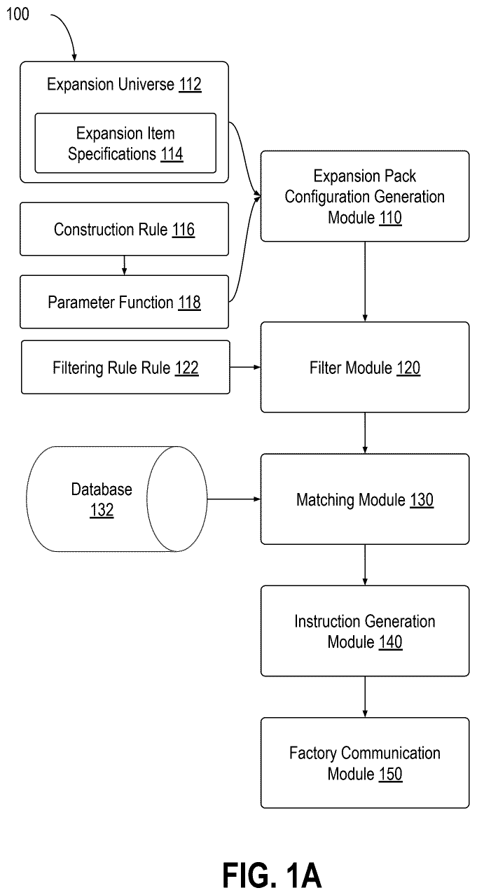

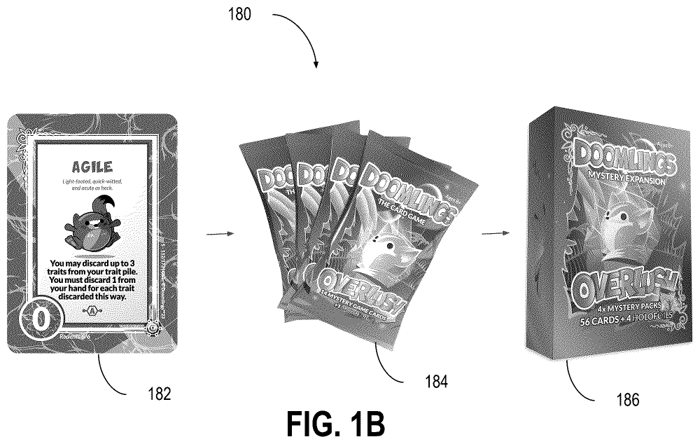

FIG. 1A illustrates a rules-based system 100 for specifying and producing at least one expansion pack, according to one or more implementations herein. System 100 may implement modules relying on rules and data to provide the user with a playable expansion set that feels random to the player.

An expansion item universe 112 may be provided. The expansion item universe may comprise a multitude of expansion item specifications 114. For example, in implementations where the expansion items are cards, the expansion item universe 112 may be a card universe, the expansion item specifications 114 may be a card specifications, the expansion item design files may be card design files, and the expansion item packs may be card packs.

A construction rule 116 may be provided (e.g., “add 20% more red cards in each box” or “prevent x mechanic from appearing with y mechanic”). The construction rule 116 may comprise a desired ratio of cards. The construction rule 116 may also or alternately comprise a restriction on appearance of a first card type and a second card type within a given expansion pack configuration.

A filtering rule 122 may be provided. The filtering rule 122 may be configured to enable filtering of combinations of expansion items as production of all combinations of expansion items may be unfeasible or uneconomical.

Each expansion item specification 114 within the expansion item universe 112 may be assigned a rarity. The rarity may be incorporated into the expansion item specification, or may be an external data point. The rarity may be, for example, a low rarity, a middling rarity, or a high rarity. As another example, the rarity may be, for example, a common rarity, an unusual rarity, a scarce rarity, an endangered rarity, a legendary rarity, or a relic rarity.

Each expansion item specification 114 within the expansion item universe may be assigned a theme. The theme may be incorporated into the expansion item specification, or may be an external data point.

A parameter function 118 may be constructed. The parameter function 118 may comprise the construction rule 116. The parameter function 118 may be configured to, based on the construction rule 116, enable creation of a multitude of expansion pack configurations. Each expansion pack configuration may be configured for functional gameplay when combined with a base game.

The multitude of expansion pack configurations may be generated at an expansion pack configuration generation module 110 based on the expansion item universe 112 and the parameter function 118. Each expansion pack configuration may comprise one or more of the expansion item specifications 114.

The multitude of expansion pack configurations may be filtered at a filter module 120 based on the filtering rule 122 to yield a manufacturing subset of expansion pack configurations. Each expansion pack configuration in the manufacturing subset of expansion pack configurations may comprise one or more of the expansion item specifications.

An expansion item design file corresponding to each expansion item specification may be retrieved, for example, from a database 132 stored on an electronic storage device in electronic communication with the processor and matched to their respective expansion item specifications 114 at a matching module 130. The design files may conform to the requirements of a manufacturer to print and/or produce the expansion item.

Each expansion item specification within the manufacturing subset of expansion pack configurations may be associated (i.e., matched) with the expansion item design file corresponding to the expansion item specification at the matching module 130.

Based on the manufacturing subset of expansion pack configurations comprising the expansion item specifications having the expansion item design files associated therewith, factory instructions may be generated at an instruction generation module 140. The factory instructions may comprise, for example, a plurality of component templates and the expansion item design files, a print sequence, and a packaging sequence. For example, with reference to FIG. 1B, which illustrates a packaging sequence 180 according to one or more implementations herein, the packaging sequence 180 may comprise a sequence of expansion items 182 to be included in a given expansion item pack 184 and a sequence of expansion item packs 184 to be included in a box 186 of expansion item packs.

The factory instructions may be sent at a factory communication module 150 via a network interface in electronic communication with the processor, to a remote device configured to enable a factory to manufacture and package expansion item packs based on the manufacturing subset of expansion pack configurations.

An inventory of manufactured expansion card packs may be received from the remote device via the network interface.

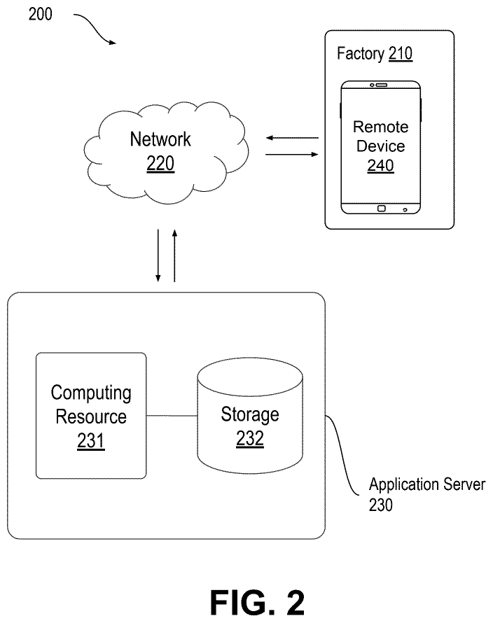

FIG. 2. Illustrates an operational environment 200 for one or more of the implementations herein. As illustrated in FIG. 2, environment 200 may include actors, including a network 220, an application server 230 having at least a computing resource 231 and a storage 232, and a remote device 240 operated by a factory 210.

Network 220 may include any variety of devices configured to enable a device communicate with other devices, such as via a wired connection and/or a wireless connection, for example, via the internet and/or other networks using, for example, TCP/IP or cellular hardware enabling wired or wireless (e.g., cellular, 2G, 3G, 4G, 4G LTE, 5G, or WiFi) communication. For example, network 220 may include, inter alia, a receiver, a transmitter, a transceiver, a modem, a network interface card, and/or an antenna.

Application server 230 may include any variety of devices configurable to perform the implementations and methods disclosed herein and interface with remote device 240 via network 220, including, for example, a server, a desktop computer, a laptop computer, a handheld computer, a tablet computing platform, a Netbook, a Smartphone, a gaming console, and/or other computing platforms.

Application server 230 may include computing resource 231. Computing resource 231 may include, for example, one or more processor(s) configured to execute machine-readable instructions for implementing all or some of the implementations herein. Computing resource 231 may be configured to access storage 232 to retrieve and/or write electronic data from and to storage 232.

Application server 230 may include storage 232. Storage 232 may be configured to host one or more databases or other forms of data storage for use in implementations herein. Storage 232 may be accessible by computing resource 231.

Remote device 240 may include any variety of devices a user (e.g., a venue agent user) may use to interface with application server 230 via network 220, including, for example, a server, a desktop computer, a laptop computer, a handheld computer, a tablet computing platform, a Netbook, a Smartphone, a gaming console, and/or other computing platforms. Remote device 240 may thus be used by an external actor, such as factory 210, to utilize the factory instructions to produce the expansion item packs and/or communicate manufactured inventory as described herein.

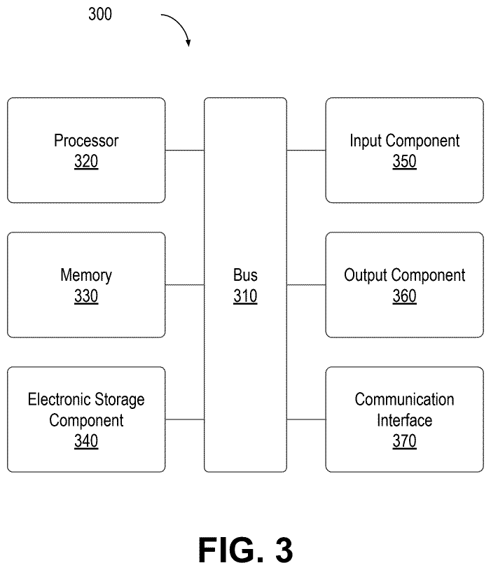

FIG. 3 is a diagram of example components of a device 300, according to one or more implementations herein, which may correspond to one or more of the device(s), network(s), resource(s), or service(s) of FIG. 2. In some implementations, one or more of the device(s), network(s), resource(s), or service(s) of FIG. 2 may include one or more devices 300 and/or one or more components of device 300, for example, according to a client/server architecture, a peer-to-peer architecture, and/or other architectures, which may include a plurality of hardware, software, and/or firmware components operating together to provide the functionality attributed herein to device 300. In some implementations, device 300 may include a distributed computing architecture (e.g., one or more individual computing platforms operating in concert to accomplish a computing task). For example, device 300 may be implemented by a cloud of computing platforms operating together as device 300. By way of non-limiting example, a given device 300 may include one or more of a server, a desktop computer, a laptop computer, a handheld computer, a tablet computing platform, a Netbook, a Smartphone, a gaming console, and/or other computing platforms.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300.

Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Such processors may or may not be all integral to the same physical device, and may in some embodiments be distributed among several devices.

Processor 320 may be configured to execute one or more of the modules disclosed herein, and/or other modules by software; hardware; firmware; some combination of software, hardware, and/or firmware; and/or other mechanisms for configuring processing capabilities on processor 320. As used herein, the term “module” may refer to any component or set of components that perform the functionality attributed to the module. This may include one or more physical processors during execution of processor readable instructions, the processor readable instructions, circuitry, hardware, storage media, or any other components. Various modules or portions thereof may be implemented in any of various ways, including procedure-based techniques, component-based techniques, and/or object-oriented techniques, among others. For example, the program instructions may be implemented using system libraries, language libraries, model-view-controller (MVC) principles, application programming interfaces (APIs), system-specific programming languages and principles, cross-platform programming languages and principles, pre-compiled programming languages, markup programming languages, stylesheet languages, “bytecode” programming languages, object-oriented programming principles or languages, other programming principles or languages, C, C++, C#, Java, JavaScript, Python, PHP, HTML, CSS, TypeScript, R, Elm, Unity, VB.Net, Visual Basic, Swift, Objective-C, Perl, Ruby, Go, SQL, Haskell, Scala, Arduino, assembly language, Microsoft Foundation Classes (MFC), Streaming SIMD Extension (SSE), or other technologies or methodologies, as desired.

It should be appreciated that although some modules disclosed herein may be illustrated for example as being implemented within a single processing unit, in embodiments in which processor 320 includes multiple processing units, one or more of modules disclosed herein may be implemented remotely from the other modules. The description of the functionality provided by the different modules disclosed herein is for illustrative purposes, and is not intended to be limiting, as any of modules described herein may provide more or less functionality than is described. For example, one or more of modules disclosed herein may be eliminated, and some or all of its functionality may be provided by other ones of modules disclosed herein. As another example, processor 320 may be configured to execute one or more additional modules that may perform some or all of the functionality attributed herein to one of modules disclosed herein.

Memory 330 includes a random-access memory, a read only memory, and/or another type of memory (e.g., a flash memory, a magnetic memory, and/or an optical memory).

Electronic storage component 340 stores information and/or software related to the operation of device 300. For example, electronic storage component 340 may include a hard disk drive, a magnetic disk drive, an optical disk drive, a solid-state disk drive, a compact disc, a digital versatile disc, and/or another type of non-transitory computer-readable medium. Implementations of electronic storage component 340 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Implementations of electronic storage component 340 may include one or both of system storage provided integrally (i.e., substantially non-removable) to device 300 and/or removable storage that is removably connectable to device 300 via, for example, a port (e.g., a USB port, an IEEE 1394 port, a THUNDERBOLT™ port, etc.) or a drive (e.g., disk drive, flash drive, or solid-state drive etc.). Electronic storage component 340 may also or alternatively include one or more virtual storage resources (e.g., cloud storage, a virtual private network, and/or other virtual storage resources). An electronic storage may store software algorithms, information determined by one or more processors, information received from one or more computing platforms, information received from one or more remote platforms, databases (e.g., structured query language (SQL) databases (e.g., MYSQL®, MARIADB®, MONGODB®), NO-SQL databases, among others), and/or other information enabling a computing platform to function as described herein.

Electronic storage component 340 may include a distributed ledger, for example, a blockchain. A blockchain can be used to maintain a continuously growing list of records called blocks. A blockchain can be used to maintain a record of transactions or events between parties in a way that is difficult to falsify. Each block in a blockchain may include several records as well as a hash of previous blocks in the blockchain. If a record in a previous block is changed, the hash may be disrupted in any following blocks. The result is that a system can easily detect whether the fidelity of data has been preserved. Similarly, to falsify a given record, a malicious actor would be required to falsify that record and all subsequent records so that the hashes end up the same. This is extremely difficult in practice. Additionally, a blockchain may be distributed among many entities. Any changes to the blockchain may be verified by comparing it to the numerous individual records.

Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator.

Output component 360 enables device 300 to provide output, such as via a display, a speaker, and/or one or more light-emitting diodes.

Communication component 370 enables device 300 to communicate with other devices, such as via a wired connection and/or a wireless connection, for example, via the internet and/or other networks using, for example, TCP/IP or cellular hardware enabling wired or wireless (e.g., cellular, 2G, 3G, 4G, 4G LTE, 5G, or WiFi) communication. For example, communication component 370 may include a receiver, a transmitter, a transceiver, a modem, a network interface card, and/or an antenna.

As used herein, “internet” may include an interconnected network of systems and a suite of protocols for the end-to-end transfer of data therebetween. A model describing may be the Transport Control Protocol and Internet Protocol (TCP/IP), which may also be referred to as the internet protocol suite. TCP/IP provides a model of four layers of abstraction: an application layer, a transport layer, an internet layer, and a link layer. The link layer may include hosts accessible without traversing a router, and thus may be determined by the configuration of the network (e.g., a hardware network implementation, a local area network, a virtual private network, or a networking tunnel). The link layer may be used to move packets of data between the internet layer interfaces of different hosts on the same link. The link layer may interface with hardware for end-to-end transmission of data. The internet layer may include the exchange of datagrams across network boundaries (e.g., from a source network to a destination network), which may be referred to as routing, and is performed using host addressing and identification over an internet protocol (IP) addressing system (e.g., IPv4, IPv6). A datagram may include a self-contained, independent, basic unit of data, including a header (e.g., including a source address, a destination address, and a type) and a payload (e.g., the data to be transported), to be transferred across a packet-switched network. The transport layer may utilize the user datagram protocol (UDP) to provide for basic data channels (e.g., via network ports) usable by applications for data exchange by establishing end-to-end, host-to-host connectivity independent of any underlying network or structure of user data. The application layer may include various user and support protocols used by applications users may use to create and exchange data, utilize services, or provide services over network connections established by the lower layers, including, for example, routing protocols, the hypertext transfer protocol (HTTP), the file transfer protocol (FTP), the simple mail transfer protocol (SMTP), and the dynamic host configuration protocol (DHCP). Such data creation and exchange in the application layer may utilize, for example, a client-server model or a peer-to-peer networking model. Data from the application layer may be encapsulated into UDP datagrams or TCP streams for interfacing with the transport layer, which may then effectuate data transfer via the lower layers.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In addition to the example configuration described herein in FIG. 3, various steps, functions, and/or operations of device 300 and the methods disclosed herein may be carried out by one or more of, for example, electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link.

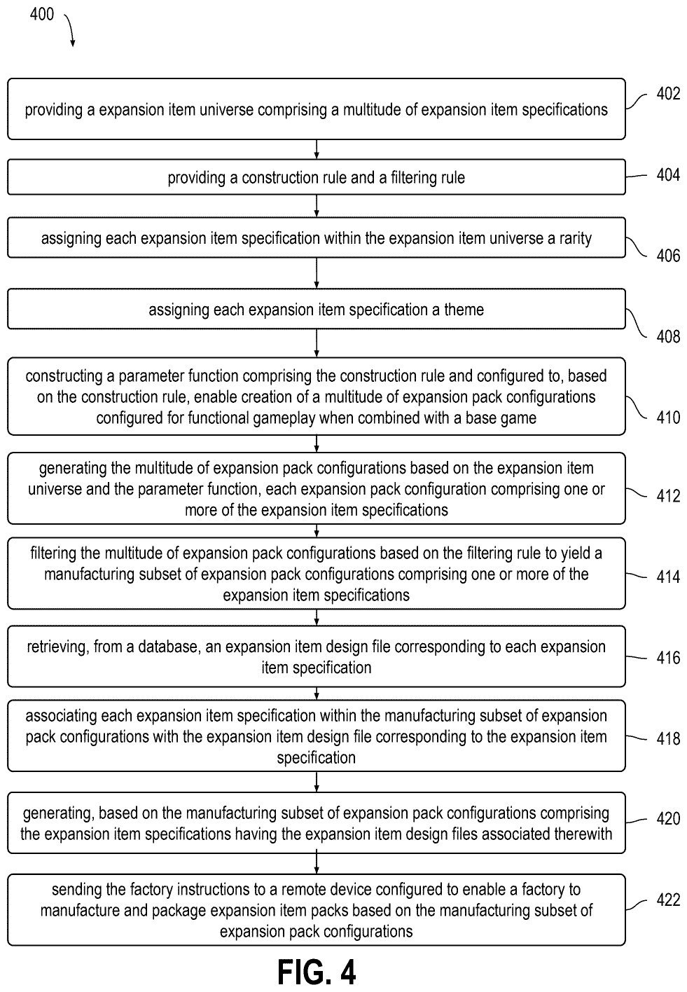

FIG. 4 is a flowchart illustrating an example method 400 for specifying and producing expansion item (e.g., cards, mechanics, categories, jokes, gameplay experiences, scenarios, goals, missions, boards, resources, heroes, avatars, boardstates, rule variants, etc.) packs of various forms for base games, according to one or more implementations herein. In some implementations, one or more operations illustrated in FIG. 4 may be performed by one or more of the devices illustrated in FIGS. 2-3. In some implementations, one or more operations illustrated in FIG. 4 may be performed by another device or a group of devices separate from or including the devices illustrated in FIGS. 2-3, such as a server device or cloud computing platform. Additionally, or alternatively, one or more operations illustrated in FIG. 4 may be performed by one or more components of device 300.

An operation 402 may include providing an expansion item universe, and may be performed alone or in combination with one or more other operations depicted in FIG. 4. The expansion item universe may comprise a multitude of expansion item specifications. For example, in implementations where the expansion items are cards, the expansion item universe may be a card universe, the expansion item specification may be a card specification, the expansion item design file may be a card design file, and the expansion item packs may be card packs.

An operation 404 may include providing a construction rule and a filtering rule and may be performed alone or in combination with one or more other operations depicted in FIG. 4. The construction rule may comprise a desired ratio of cards. The construction rule may also or alternately comprise a restriction on appearance of a first card type and a second card type within a given expansion pack configuration.

An operation 406 may include assigning each expansion item specification within the expansion item universe a rarity and may be performed alone or in combination with one or more other operations depicted in FIG. 4. The rarity may be incorporated into the expansion item specification or may be an external data point. The rarity may be, for example, a low rarity, a middling rarity, or a high rarity. As another example, the rarity may be, for example, a common rarity, an unusual rarity, a scarce rarity, an endangered rarity, a legendary rarity, or a relic rarity.

An operation 408 may include assigning each expansion item specification within the expansion item universe a theme and may be performed alone or in combination with one or more other operations depicted in FIG. 4. The theme may be incorporated into the expansion item specification or may be an external data point.

An operation 410 may include constructing a parameter function and may be performed alone or in combination with one or more other operations depicted in FIG. 4. The parameter function may comprise the construction rule. The parameter function may be configured to, based on the construction rule, enable creation of a multitude of expansion pack configurations. Each expansion pack configuration may be configured for functional gameplay when combined with a base game.

An operation 412 may include generating the multitude of expansion pack configurations based on the expansion item universe and the parameter function and may be performed alone or in combination with one or more other operations depicted in FIG. 4. Each expansion pack configuration may comprise one or more of the expansion item specifications.

An operation 414 may include filtering the multitude of expansion pack configurations based on the filtering rule to yield a manufacturing subset of expansion pack configurations and may be performed alone or in combination with one or more other operations depicted in FIG. 4. Each expansion pack configuration in the manufacturing subset of expansion pack configurations may comprise one or more of the expansion item specifications.

An operation 416 may include retrieving an expansion item design file corresponding to each expansion item specification, for example, from a database stored on an electronic storage device in electronic communication with the processor and may be performed alone or in combination with one or more other operations depicted in FIG. 4.

An operation 418 may include associating each expansion item specification within the manufacturing subset of expansion pack configurations with the expansion item design file corresponding to the expansion item specification and may be performed alone or in combination with one or more other operations depicted in FIG. 4.

An operation 420 may include, based on the manufacturing subset of expansion pack configurations comprising the expansion item specifications having the expansion item design files associated therewith, generating the factory instructions, and may be performed alone or in combination with one or more other operations depicted in FIG. 4. The factory instructions may comprise, for example, a plurality of component templates and the expansion item design files, a print sequence, and a packaging sequence. For example, the packaging sequence may comprise a sequence of expansion items to be included in a given expansion item pack and a sequence of expansion item packs to be included in a box of expansion item packs.

An operation 422 may include sending the factory instructions via a network interface in electronic communication with the processor, to a remote device configured to enable a factory to manufacture and package expansion item packs based on the manufacturing subset of expansion pack configurations and may be performed alone or in combination with one or more other operations depicted in FIG. 4.

Although FIG. 4 depicts example method 400, and operations thereof, in some implementations, a method illustrated herein may include additional operations, fewer operations, differently arranged operations, or different operations than the operations depicted in FIG. 4. Moreover, or in the alternative, two or more of the operations depicted in FIG. 4 may be performed at least partially in parallel.

Various characteristics, advantages, implementations, embodiments, and/or examples relating to the invention have been described in the foregoing description with reference to the accompanying drawings. However, the above description and drawings are illustrative only. The invention is not limited to the illustrated implementations, embodiments, and/or examples, and all implementations, embodiments, and/or examples of the invention need not necessarily achieve every advantage or purpose, or possess every characteristic, identified herein. Accordingly, various changes, modifications, or omissions may be effected by one skilled in the art without departing from the scope or spirit of the invention, which is limited only by the appended claims. Although example materials and dimensions have been provided, the invention is not limited to such materials or dimensions unless specifically required by the language of a claim. Elements and uses of the above-described implementations, embodiments, and/or examples can be rearranged and combined in manners other than specifically described above, with any and all permutations within the scope of the invention, as limited only by the appended claims.

In the claims, various portions may be prefaced with letter or number references for convenience. However, use of such references does not imply a temporal or ordered relationship not otherwise required by the language of the claims. Unless the phrase ‘means for’ or ‘step for’ appears in a particular claim or claim limitation, such claim or claim limitation should not be interpreted to invoke 35 U.S.C. § 112 (f).

As used herein, satisfying a threshold may, depending on the context, refer to a value being greater than the threshold, greater than or equal to the threshold, less than the threshold, less than or equal to the threshold, equal to the threshold, and/or the like, depending on the context.

As used in the specification and in the claims, use of “and” to join elements in a list forms a group of all elements of the list. For example, a list described as comprising A, B, and C defines a list that includes A, includes B, and includes C. As used in the specification and in the claims, use of “or” to join elements in a list forms a group of at least one element of the list. For example, a list described as comprising A, B, or C defines a list that may include A, may include B, may include C, may include any subset of A, B, and C, or may include A, B, and C. Unless otherwise stated, lists herein are inclusive, that is, lists are not limited to the stated elements and may be combined with other elements not specifically stated in a list. As used in the specification and in the claims, the singular form of ‘a’, ‘an’, and ‘the’ include plural referents (e.g., one or more of the referent) unless the context clearly dictates otherwise.

It is to be expressly understood that the drawings are for the purpose of illustration and description only and are not intended as a definition of the limits of the invention.

It is to be expressly understood that the drawings are for the purpose of illustration and description only and are not intended as a definition of the limits of the invention.

Unless otherwise stated, any range of values disclosed herein sets out a lower limit value and an upper limit value, and such ranges include all values and ranges between and including the limit values of the stated range, and all values and ranges substantially within the stated range as defined by the order of magnitude of the stated range.

The inventors hereby state their intent to rely on the Doctrine of Equivalents to determine and assess the reasonably fair scope of their invention as pertains to any apparatus not materially departing from but outside the literal scope of the invention as set out in the following claims.

We claim:

1. A method, comprising, using a processor:
providing an expansion item universe comprising a multitude of expansion item specifications;
providing a construction rule and a filtering rule;
assigning each expansion item specification within the expansion item universe a rarity;
assigning each expansion item specification a theme;
constructing a parameter function comprising the construction rule and configured to, based on the construction rule, enable creation of a multitude of expansion pack configurations configured for functional gameplay when combined with a base game;
generating the multitude of expansion pack configurations based on the expansion item universe and the parameter function, each expansion pack configuration comprising one or more of the expansion item specifications;
filtering the multitude of expansion pack configurations based on the filtering rule to yield a manufacturing subset of expansion pack configurations comprising one or more of the expansion item specifications;
retrieving, from a database stored on an electronic storage device in electronic communication with the processor, an expansion item design file corresponding to each expansion item specification;
associating each expansion item specification within the manufacturing subset of expansion pack configurations with the expansion item design file corresponding to the expansion item specification;
generating, based on the manufacturing subset of expansion pack configurations comprising the expansion item specifications having the expansion item design files associated therewith, factory instructions comprising:
a plurality of component templates and the expansion item design files;
a print sequence; and
a packaging sequence; and
sending the factory instructions, via a network interface in electronic communication with the processor, to a remote device configured to enable a factory to manufacture and package expansion item packs based on the manufacturing subset of expansion pack configurations.

2. The method of claim 1, wherein:
the expansion item universe is a card universe;
the expansion item specification is a card specification;
the expansion item design file is a card design file; and
the expansion item packs are card packs.

3. The method of claim 1, wherein rarity comprises a low rarity, a middling rarity, or a high rarity.

4. The method of claim 1, wherein rarity comprises a common rarity, an unusual rarity, a scarce rarity, an endangered rarity, a legendary rarity, or a relic rarity.

5. The method of claim 1, wherein the construction rule comprises a desired ratio of cards.

6. The method of claim 1, wherein the construction rule comprises a restriction on appearance of a first card type and a second card type within a given expansion pack configuration.

7. The method of claim 1, further comprising receiving, via the network interface an inventory of manufactured expansion card packs from the remote device.

8. The method of claim 1, wherein the packaging sequence comprises:
a sequence of expansion items to be included in a given expansion item pack; and
a sequence of expansion item packs to be included in a box of expansion item packs.

9. A system, comprising:
a processor;
an electronic storage device in electronic communication with the processor, the electronic storage device having a database stored thereon; and
a network interface in electronic communication with the processor;
wherein the processor is configured to perform a method comprising:
providing an expansion item universe comprising a multitude of expansion item specifications;
providing a construction rule and a filtering rule;
assigning each expansion item specification within the expansion item universe a rarity;
assigning each expansion item specification a theme;
constructing a parameter function comprising the construction rule and configured to, based on the construction rule, enable creation of a multitude of expansion pack configurations configured for functional gameplay when combined with a base game;
generating the multitude of expansion pack configurations based on the expansion item universe and the parameter function, each expansion pack configuration comprising one or more of the expansion item specifications;
filtering the multitude of expansion pack configurations based on the filtering rule to yield a manufacturing subset of expansion pack configurations comprising one or more of the expansion item specifications;
retrieving, from the database, an expansion item design file corresponding to each expansion item specification;
associating each expansion item specification within the manufacturing subset of expansion pack configurations with the expansion item design file corresponding to the expansion item specification;
generating, based on the manufacturing subset of expansion pack configurations comprising the expansion item specifications having the expansion item design files associated therewith, factory instructions comprising:
a plurality of component templates and the expansion item design files;
a print sequence; and
a packaging sequence; and
sending the factory instructions, via the network interface, to a remote device configured to enable a factory to manufacture and package expansion item packs based on the manufacturing subset of expansion pack configurations.

10. The system of claim 9, wherein:
the expansion item universe is a card universe;
the expansion item specification is a card specification;
the expansion item design file is a card design file; and
the expansion item packs are card packs.

11. The system of claim 9, wherein rarity comprises a low rarity, a middling rarity, or a high rarity.

12. The system of claim 9, wherein rarity comprises a common rarity, an unusual rarity, a scarce rarity, an endangered rarity, a legendary rarity, or a relic rarity.

13. The system of claim 9, wherein the construction rule comprises a desired ratio of cards.

14. The system of claim 9, wherein the construction rule comprises a restriction on appearance of a first card type and a second card type within a given expansion pack configuration.

15. The system of claim 9, further comprising receiving, via the network interface an inventory of manufactured expansion card packs from the remote device.

16. The system of claim 9, wherein the packaging sequence comprises:
a sequence of expansion items to be included in a given expansion item pack; and
a sequence of expansion item packs to be included in a box of expansion item packs.

17. A tangible, non-transient, computer-readable media having instructions thereupon which when implemented by a processor cause the processor to perform a method comprising:
providing an expansion item universe comprising a multitude of expansion item specifications;
providing a construction rule and a filtering rule;
assigning each expansion item specification within the expansion item universe a rarity;
assigning each expansion item specification a theme;
constructing a parameter function comprising the construction rule and configured to, based on the construction rule, enable creation of a multitude of expansion pack configurations configured for functional gameplay when combined with a base game;
generating the multitude of expansion pack configurations based on the expansion item universe and the parameter function, each expansion pack configuration comprising one or more of the expansion item specifications;
filtering the multitude of expansion pack configurations based on the filtering rule to yield a manufacturing subset of expansion pack configurations comprising one or more of the expansion item specifications;
retrieving, from a database stored on an electronic storage device in electronic communication with the processor, an expansion item design file corresponding to each expansion item specification;
associating each expansion item specification within the manufacturing subset of expansion pack configurations with the expansion item design file corresponding to the expansion item specification;
generating, based on the manufacturing subset of expansion pack configurations comprising the expansion item specifications having the expansion item design files associated therewith, factory instructions comprising:
a plurality of component templates and the expansion item design files;
a print sequence; and
a packaging sequence; and
sending the factory instructions, via a network interface in electronic communication with the processor, to a remote device configured to enable a factory to manufacture and package expansion item packs based on the manufacturing subset of expansion pack configurations.

18. The tangible, non-transient, computer-readable media of claim 17, wherein rarity comprises a common rarity, an unusual rarity, a scarce rarity, an endangered rarity, a legendary rarity, or a relic rarity.

19. The tangible, non-transient, computer-readable media of claim 17, wherein the construction rule comprises a desired ratio of cards and a restriction on appearance of a first card type and a second card type within a given expansion pack configuration.

20. The tangible, non-transient, computer-readable media of claim 17, wherein the packaging sequence comprises:
a sequence of expansion items to be included in a given expansion item pack; and
a sequence of expansion item packs to be included in a box of expansion item packs.
